(19) United States
(12) Patent Application Publication
(10) Pub. No.: US 2013/0334027 A1
(43) Pub. Date: Dec. 19, 2013

(54) System to Improve Distillate Quality and Recovery in a Distillation Column

(71) Applicants: George R. Winter, Fond Du Lac, WI (US); Zvi Mervhav, Kiryat Ata (IL)

(72) Inventors: George R. Winter, Fond Du Lac, WI (US); Zvi Mervhav, Kiryat Ata (IL)

(21) Appl. No.: 13/920,536

(22) Filed: Jun. 18, 2013

Related U.S. Application Data
(60) Provisional application No. 61/661,574, filed on Jun. 19, 2012.

(51) Int. Cl. B01D 3/42

(52) U.S. Cl. CPC B01D 3/42
USPC 203/2; 203/44

(57) ABSTRACT

Processes and systems for improving the quality and yield of distillate columns.

### RELATED APPLICATIONS

This application claims the benefit of co-pending U.S. Provisional Patent Application Ser. No. 61/661,574, filed 19 Jun. 2012.

### BACKGROUND OF THE INVENTION

The present invention is directed towards processes where a mixture of liquid and vapor is to be separated into a vapor stream and a liquid stream with minimal entrainment of liquid into the vapor stream. A common means of reducing entrainment of feed liquid in the rising vapor is to scrub the vapor above the feed point with a suitable liquid that is not as finely dispersed as the liquid entrained in the vapor, then separate liquid from vapor.

In distillation columns fed with a partially-vaporized feed stream, this method is commonly practiced by:
Create a wash zone above the feed point containing a means of enhancing liquid-vapor contact such as loose packing, structured packing, or trays; and
Distribute some condensate from the vapor stream, onto the top of the wash zone contacting means.

The liquid exiting the wash zone may be allowed to fall into the liquid settled from the feed, or may be collected and removed from the vessel.

In such distillation systems, there is always a need to improve the quality and increase the yield of the distillate, as well as and the capacity of the equipment to handle more feed.

### SUMMARY OF THE INVENTION

The present invention provides processes for improving the quality and yield of distillate and the feed capacity of a distillation column.

In one aspect of the invention, an energy balancing system is provided in the heavy vacuum gas oil (“HVGO”) liquid used to wet the packing in the wash section.

In another aspect of the present invention, the energy balancing system described above is combined with recycling of wash oil.

### BRIEF DESCRIPTION OF THE DRAWINGS

FIG. 1 is a schematic view of a typical vacuum distillation column.

FIG. 2 is a graphical representation of a base case comparing the vapor rate in ft3/sec at various stages of a distillation process.

FIG. 3 is a further graphical representation of the base case of FIG. 2 comparing the C factor in ft/s at various stages of a distillation process.

FIG. 4 is a graphical representation as shown in FIG. 3, with the base case compared to a cold HGVO process and a wash bed heat removal process according to the present invention.

### DESCRIPTION OF THE PREFERRED EMBODIMENT

Although the disclosure hereof is detailed and exact to enable those skilled in the art to practice the invention, the physical embodiments herein disclosed merely exemplify the invention which may be embodied in other specific structures. While the preferred embodiment has been described, the details may be changed without departing from the invention, which is defined by the claims.

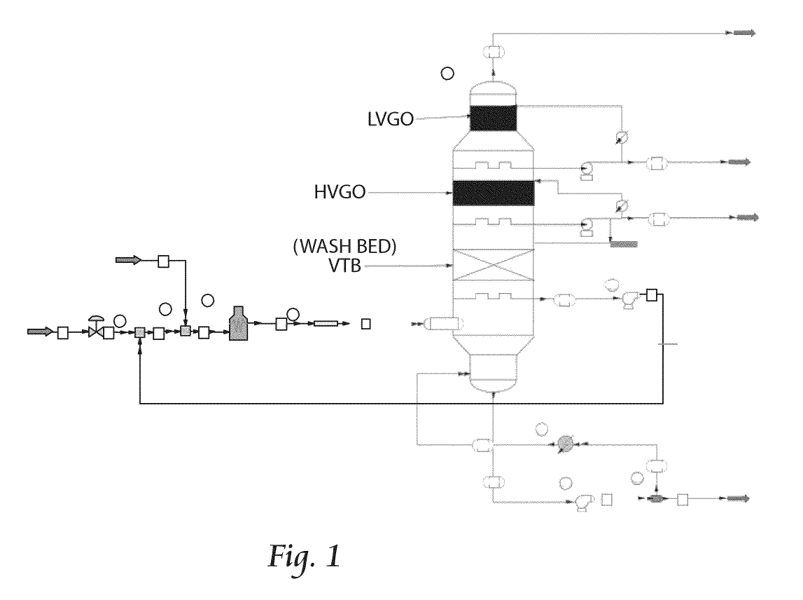

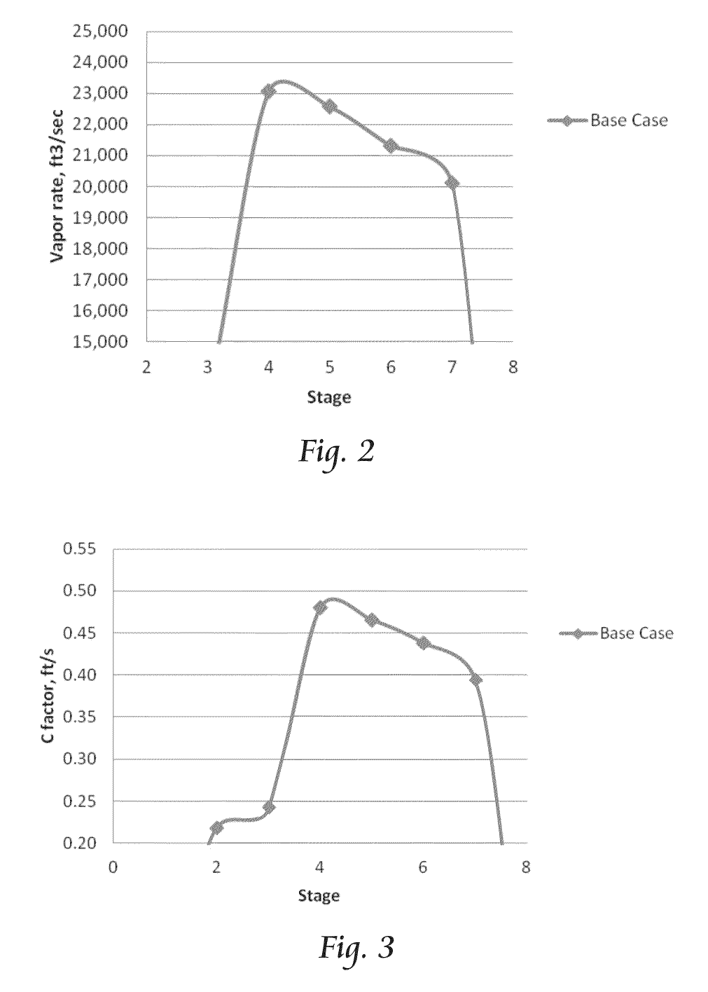

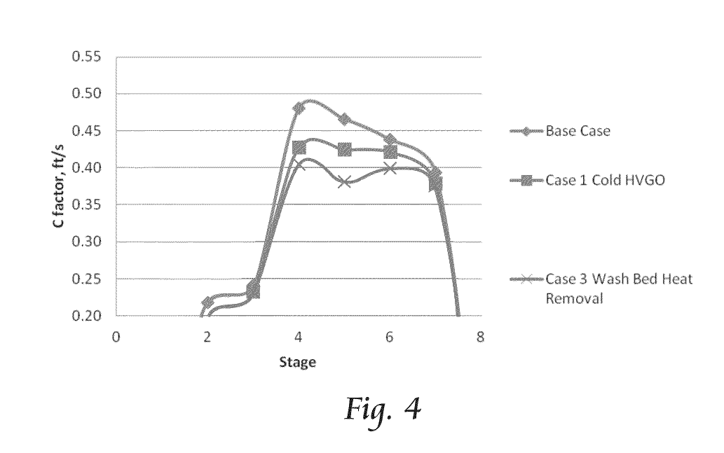

Referring to FIG. 1, a typical vacuum distillation column in a Crude Oil Distillation Unit is used to illustrate the idea and its usefulness. The vacuum column processes the heavy portion of the crude oil from the bottom of the atmospheric column (“ATB”). Most vacuum distillation columns separate the ATB into 3 streams: light vacuum gas oil (“LVGO”), heavy vacuum gas oil (“HVGO”) and vacuum column bottoms (“VTB”). It has been previously recognized that the wash section can remove entrained asphaltenes and other solids from the upcoming vapor without increasing the duty on the charge heater, such as described in U.S. Pub. No. 2011/0226607, which is incorporated by reference. The present application describes how to achieve this result and also increase the capacity of the unit.

Just upstream of the column, the mixture of liquid and vapor drops in pressure in the transfer line from the heater to the column, and then expands further as the mixture enters the flash zone inside and near the bottom of the column. There is no significant loss or gain of heat in the transfer line, so the expansion is isenthalpic. At the pressure decreases, some of the liquid vaporizes. At isenthalpic conditions, the temperature of the mixture drops so that the enthalpy of the new mixture of vapor and liquid equals its enthalpy at the outlet of the heater.

For those skilled in the art, it is well known that the volumetric flow rate of vapor increases as these vapors flow up from the flash zone to the wash zone and then to the HVGO zone. As with the isenthalpic expansion in the transfer line, the amount of vapor leaving the wash zone is higher than the amount of vapor entering, and the temperature is lower. Most of the increase in vapor rate is due to refluxing to the wash zone a liquid comprising components having boiling points lower than the dew point of the rising vapor. When such liquid and vapor come into contact, there occurs an isenthalpic exchange of components between phases to establish equilibrium of vapor pressures between the phases, which occurs at a temperature lower than that in the flash zone. The decrease in specific enthalpy of the vapor is compensated by evaporation of some of the liquid added, resulting in an increase in mass flow rate of the vapor as it passes upward through the contacting space.

The re-evaporation of liquid in the wash zone creates additional mass flow into the HVGO section of the column, where in most vacuum columns flooding is a constraint on vapor flow.

To illustrate, the temperature at the flash zone of one column we studied was 392 C. At the top of the wash section, this temperature dropped to 376 C and by the top of the HVGO section the temperature dropped to 289 C. These temperatures reflect the decrease in molecular weight of the fluids, with resulting decrease in dew points and bubble points, as they condense and boil, respectively, at lower pressure.

At 392 C, the column had 368,000 kilograms per hour of vapor in the top of the flash zone. At the top of the wash section, where the pressure had dropped by almost 5 mBar from that in the flash zone, the temperature had decreased almost 17 C. As a result, the flow of vapor increased to 411,000 kilograms per hour.

Pressure drop through the HVGO trap tray reduces pressure at the inlet to the HVGO section, which in an isenthalpic expansion would reduce the dew point of the vapor. The temperature dropped to 359 C, so the vapor increased to 440,000 kilograms per hour. In the HVGO fractionation section, where the pressure is now almost 5 mBar below the pressure in the wash section, the temperature is 289 C, and the flow of vapor is up to 455,000 kilograms per hour.

With the drop in pressure, the volumetric expansion of the vapor flow rates is even higher than shown with the values for kilograms per hour. To measure the effects of volumetric flow rate and the density of the streams on the capacity of the vacuum column, design engineers calculate a term known as the “Packing C-Factor.” This is defined as the superficial velocity of the vapor times the square root of the ratio of the density of the vapor to the difference between the densities of the liquid and the vapor. The C-Factors for the wash bed and HVGO bed in the example column are 0.134 and 0.143 meters per second, respectively.

The significance of C-factor is that it is a measure of the flow rate of vapor that the packing will allow without flooding. For packed beds with relatively low amounts of down-flowing liquid, such as is typical for vacuum columns, the C-factors is a reasonable approximation of approach to flooding. For packed beds with relatively high amounts of liquid, such as the wash bed, the increases in capacity are probably estimated better using F-factors, an algorithm used by KochGlitsch for packed beds with significant liquid loads.

For the column in question, the packing seemed to flood at a C-Factor of 0.137 although the calculations indicated that it should not flood until the C-Factor was above 0.152.

### First Improvement

The first improvement is to provide a system to improve, and eventually optimize, the temperature and flow rate of the HVGO liquid used to wet the packing in the wash section. Using the same conditions as above and optimizing the enthalpy of the HVGO, the highest flow rate of vapor in the HVGO section drops from 455,000 kilograms per hour to 432,000 kilograms per hour, reducing the C-Factor from 0.143 to 0.131. These optimizations reduce to a minimum the percent flood in the packed sections of the column.

The reduction of the C-Factor in the HVGO bed from 0.143 to 0.131 shows the value of the improvement. As a result, the feed rate to the column can be increased by the ratio of the two values, or about 10%, which increases in the range of 6 to 17%.

The main advantage of this improvement is that it usually can be implemented without shutting down the unit and changing the internals in the vacuum column. Because the HVGO pumparound and product streams flow through heat exchangers after the HVGO pump, lower temperature liquid is readily available. By tying into the existing heat exchange circuit, possibly making certain other changes that are dependent on the design of the individual unit, and modifying the operating parameter targets or perhaps the control algorithms, the capacity of the vacuum column can be increased without interrupting operation.

### Second Improvement

A second improvement in the flow scheme is to combine the above idea with recycling of wash oil. This combination requires revising the energy balance of the slop wax liquid that is recycled to the top of the wash bed. Since such systems are rarely installed, and since high wash oil recycle rates are rarely used, this flow scheme usually requires new pumps, lines, exchanger(s), at least one new control valve, and new operating targets or a new control algorithm. The advantage, however, is that because only the highest-boiling of the components of the vapor are condensed into the circulating liquid, the flashing of liquid to vapor in the wash zone is reduced even more so that the potential increase in feed is higher than using the above-described First Improvement.

Using the same starting point as described above in the “First Improvement,” the C-Factor at the inlet of the HVGO section can be reduced using this flow scheme to 0.122, an improvement of almost 20%.

### Control System

As with most process variables, there is an optimum for the amount of energy removed from each section of the vacuum column. If too much heat is removed from the downflowing liquid, then the liquid will condense enough vapor to reduce the yield of HVGO. If the downflowing liquid is cooled too much, then the vapor rate will be above the optimum, which reduces the capacity.

Since the amount of superheat in the up-flowing vapors depends on the temperature profile across the wash bed, the temperature difference between the top and the bottom of the wash bed can be used as part of the control system to adjust the amount of heat removed from the system. With the temperature difference across a portion of the bed indicating the changes in composition and pressure, the level on the wash oil collector tray can be used to control the material balance for the wash section.

A second control system would be to let the control algorithm set the flow rate of wash oil removed from the circuits around the vacuum column and use the level controller at the collector tray at the bottom of the wash section to determine the amount of the circulation that should flow through the system. As this level changes, the control algorithm adjusts the variables to return the reading to its target.

A further enhancement of this control system is to use the flow rates, compositions and temperature of the products to calculate the heat balance and, from that, set the control system to optimize the enthalpy in the up-flowing vapor.

The idea for controlling the excess enthalpy in the wash bed and HVGO bed is different from public information in the following ways:
1. It is different from most commercial columns because the wash oil from the collector tray at the bottom of the wash zone is either sent to the inlet of the vacuum heater or blended with the resid. This is illustrated in the article by Hanson and Martin in Oil & Gas Journal dated Mar. 18, 2002.
2. It is different from those published designs that recycle wash oil from the bottom to the top of the packing in the wash bed because these designs do not optimize the enthalpy of the up-flowing vapor stream.

The authors do not know of any columns with this design that were actually built and have nothing more than anecdotal verbal reports that such designs were conceived. A search of US patents available at Google.com/patents as of 31 May 2012 showed no patents for this design, or any references to this design.
3. It is different from a conceptual design that shows the option to use heat removal in the wash oil circuit because
   a. An unknown and perhaps uncontrolled amount of cooling is provided in the exchanger in the wash oil recycle.
   b. There is no control of the heat removal based on the temperatures or the level in the wash section.
   c. There are no algorithms to optimize the vapors going to the HVGO section.

As with item 2, the authors do not know of any designs of this type that were actually built. A search of US patents available at Google.com/patents as of 31 May 2012 showed no patents for this design, or any references to this design.
4. It is different from the article dated Oct. 14, 2002 in the Oil & Gas Journal by Barletta and Golden because they taught how to replace trays with structured packing, did not include the recycle of wash oil and did not include the optimization or even the control of the heat removal.
5. It is different from U.S. Pat. No. 4,308,130 because we teach the advantages of controlling and optimizing the vapor flowing up through the internals in the vacuum column.

The benefits we can claim with control and optimization of the enthalpies of the up-flowing vapors in the wash bed include:
1. Less vapor to the HVGO section at constant HVGO yield, or higher HVGO yield as a percentage of feed to the vacuum column, or both.
2. Higher feed rate with the same size fractionation column.

The foregoing is considered as illustrative only of the principles of the invention. Furthermore, since numerous modifications and changes will readily occur to those skilled in the art, it is not desired to limit the invention to the exact construction and operation shown and described. While the preferred embodiment has been described, the details may be changed without departing from the invention, which is defined by the claims.

We claim:

1. A process for improving the quality and yield of distillate while reducing the volatile content of the bottoms product from a column fed with partially-vaporized feed, the column comprising a wash oil recycle stream, a vapor wash section, a wash zone, at least one pump, and at least one heat exchange, the process including a liquid distillate used for wash oil, the process comprising:
an energy balancing system on the wash oil recycle stream to remove an amount of energy from the vapor wash section sufficient to mass balance the wash zone without reflux of distillate, or at least one of the heat exchangers on the distillate refluxed to the top of the wash zone to remove an amount of heat sufficient to prevent an increase in the flow rate of the vapor in the wash section, or any combination of these two system.

2. The process of claim 1 in which a control system uses the temperatures at the top and bottom of the wash section as basis for modulating heat removal in the heat exchangers in wash bed pumparound and/or distillate pumpdown.

3. The process of claim 1 in which the amount of energy removed from the wash oil recycle stream or the liquid distillate used for wash oil or a combination of these two is modulated to control the level of the liquid in the collector tray for the wash section.

4. The process of claim 1 in which a control system uses temperatures at the top and bottom of the wash section, the flows of the pump around streams and the flows of products from the column in a calculation algorithm to perform the heat balance calculations around the wash bed and the flow rate of vapor.

5. The process of claim 4 in which heat removal from the distillate reflux to the wash section or the wash oil recycle is modulated to hold the flow rate of liquid constant.
